(19) United States
(12) Patent Application Publication
(10) Pub. No.: US 2005/0173338 A1
(43) Pub. Date: Aug. 11, 2005

(54) Method of treating water for fine suspended solids using confined exposure to a living colony of hydrocotyle ranunculoides

(76) Inventor: Mary Katharine Bretsch, Portland, OR (US)

Correspondence Address: Mary Katharine Bretsch, 3336 SE Yamhill Street, Portland, OR, 97214-4277, US

(21) Appl. No.: 10/776,888

(22) Filed: Feb. 11, 2004

(51) Int. Cl. C02F 3/32

(52) U.S. Cl. 210/602

(57) ABSTRACT

A method for treating water for fine suspended solids, such as those found in roadway runoff and urban stormwater, construction site erosion or runoff from sites where resource extraction and industrial activities are conducted. Said method consisting of confined exposure to a living colony of the North American native aquatic plant, Hydrocotyle ranunculoides, as a means to induce flocculation and thereby allow settling and removal of the accumulated solids. In a preferred embodiment, a means of confining the water with the plant material for treatment is provided in the form of an open tank or pool providing for a water depth of 1 meter or less. In a preferred embodiment of the method, the water is confined with a mature living plant colony which substantially covers the surface of the water, forming a dense floating matt. In a preferred embodiment of this method, the confined exposure of the water with the plant colony is maintained for 24 hours or more.

### BACKGROUND OF THE INVENTION—FIELD OF INVENTION

This invention relates to water treatment, specifically the treatment of water for fine suspended solids by confined exposure to a living colony of the aquatic plant Hydrocotyle ranunculoides as a means of flocculating the suspended solids to induce their settling and thereby to facilitate their removal.

### BACKGROUND—DISCUSSION OF PRIOR ART

The method of the present invention has substantial advantages in economy, safety, adaptability and environmental impact over prior methods. Competing technologies include polyacrylamide chemical flocculants such as those supplied by Delta Pollution Control, Inc., (30540 SE 84^{th}, Preston, Wash. 98050, 1-425-222-4544) and MarTint (PO Box 1370, Cornelius, N.C. 28031, 1-704-895-6914, martintenvironmental.com), electro-flocculation, permeable membrane technologies such as those sold by PTI Advanced Filtration Inc. (2340 Eastman Avenue, Oxnard, Calif. 93030, 1-805-604-3400, www.pti-afi.com), and other fine filter or flocculation methods for simple or contaminated suspended solids in water.

Additional discussion of prior art and applicant's invention can be found in the applicant's peer-reviewed technical paper, “Phytoremediation of Storm Water Residuals Decant with Hydrocotyle Ranunculoides”, a copy of which is included with this application. This paper was published in late February, 2003, as part of the proceedings of the national conference, Urban Storm Water: Enhancing Programs at the Local Level, sponsored by the Chicago Botanic Garden and the U.S. Environmental Protection Agency's Region 5—Water Division, Offices of Wastewater Management and Research and Development and Conservation Technology Information Center. Additional background information and discussion of prior art can be found in the Oregon Department of Transportation (ODOT) research reports, Roadwaste: Issues and Options, (FHWA-OR-RD-99-05), Roadwaste Management: Field Trials, of which applicant is a co-author (SPR 335), and Roadwaste Management: A Tool for Developing District Plans, APWA Edition (FHWA-OR-RD-01-07). Complete Adobe Portable Document File (PDF) versions of these documents are provided on the CD which accompanies this document, or for download from the ODOT Research Division's web site.

The CD accompanying this document also includes a copy of applicant's paper presented to the Transportation Research Board's summer workshop on environmental risks associated with municipal Vactor© waste, which discusses the significance of fines as an environmental risk factor. Fine suspended solids such as those generated by urban transportation systems, construction activities and resource extraction activities find their way into stormwater and present special water treatment challenges.

### BACKGROUND—OBJECTS AND ADVANTAGES

Accordingly, several objects and advantages of my method for treating water for fine suspended solids are:

(a) to provide more economical operation than competing technologies;

(b) to provide more economical implementation than competing technologies;

(c) to provide removal of fine suspended solids such as those 30 microns and less in size;

(d) to provide greater adaptability to existing facilities and various physical settings;

(e) to avoid some of the substantial worker safety risks of competing methods; and,

(f) to provide reduced environmental impact compared to competing technologies.

Discussion illustrating these objects and advantages follows:

(a) Economy of operation. An embodiment of applicant's new method has proven, in full scale experimental trial, to cost on the order of 1/10th or better of competing technologies. Costs per treated gallon on the order of US$0.01 per gallon have been demonstrated using applicant's method. Compared to the operations and maintenance demands of the competing technologies of electro-flocculation, chemical flocculation or advanced filtration, operation and maintenance demands of embodiments of applicant's new method are very simple. Full scale trial of applicant's method demonstrated that, except for required cleaning to remove settled accumulated solids, systems using a preferred embodiment of this method can be operated almost completely passively for long periods of time.
(b) Economy of implementation. Implementation of this method using adaptation of existing containment systems to provide the required means of confinement of the water to be treated with the plant colony has been demonstrated. Newly constructed simple embodiments need not be complex. Heretofore, there has been a substantial tradeoff between expense and effectiveness in methods for removing ultra-fine suspended solids from water, especially in urban and transportation system runoff and construction site erosion. Applicant's method provides for effective removal of such fine suspended solids at comparatively minimal cost.
(c) Removal of fine suspended solids such as soil particles 30 microns and less. Some competing technologies are less successful at removing fine or ultra-fine suspended solids such as soils particles 30 microns and less. Fine suspended solids such as soil particles 30 microns and less, for instance as commonly found in waters such as highway and urban runoff and construction site erosion, can be resistant to gravity settling, can preferentially bind priority pollutants such as lead, and have been identified as a specific risk to fisheries, including threatened and endangered fisheries. Facilitating their effective removal at reasonable cost is a great benefit. Competing technologies which are effective at removing fine or ultra-fine suspended solids such as soil particles 30 microns and less can be as expensive and complex as drinking water treatment systems (e.g. chemical treatment or permeable membrane technologies).
(d) Adaptability for physical setting: The means for providing confined exposure to a living colony of H. ranunculoides used to implement the method of this invention can be adapted for a variety of circumstances and physical settings other than standard industrial settings. For example, temporary and portable means of providing confined exposure to a colony of H. ranunculoides are both feasible and economic. For instance, the means of providing confined exposure could be in the form of a portable, translucent plastic tank. The means of providing confined exposure could be provided by adapting a wide range of existing containment facilities, such as detention ponds, tanks, lined ponds or ditches. The means of providing confined exposure could be in the form of a grated linear channel to fit in an existing right-of-way. Means of providing confined exposure to an H. ranunculoides colony in the form of such a grated linear channel could be made operable while at the same time supporting pedestrian and vehicular traffic. A means of providing confined exposure to a living colony of H. ranunculoides could be provided using translucent pipe, which could even be elevated, if it was desirable to do so. Because competing technologies are substantially more complex mechanically or involve chemical handling, and are more labor-intensive to operate, they are adapted and maintained outside of fixed industrial settings only with greater difficulty and expense.
(e) Worker safety: The method of this invention presents advantages for worker safety over competing technologies in that neither electrical power nor chemical handling are required to implement it. The wide, adaptable variety of means by which this invention's confined exposure to a living colony of H. ranunculoides can be provided also creates the potential of additional worker safety benefits. For instance, the means by which confinement of the water with the H. ranunculoides plant material can be accomplished includes basins shallow enough that confined space entry protocols will not be required for maintenance activities.
(f) Environmental impact: The method of this invention requires lesser energy and other resource inputs compared to more resource intensive and complex systems, such as flocculation using the application of chemicals or electrical current, or advanced filter or membrane technologies. The plants make use of free energy from the sun. The plants consume carbon dioxide and give off oxygen. This invention is reliably “fish safe” in that it presents no appreciable danger to downstream resources.

### BACKGROUND—THEORY OF OPERATION

Hydrocotyle ranunculoides is a free floating aquatic plant, native in North America, common in the Northwest, and available from commercial native plant nurseries such as Wallace W Hansen Native Plants of the Northwest Native Plant Nursery & Gardens (2158 Bower Ct S.E., Salem, Oreg. 97301, 1-503-581-2638, www.nwplants.com/business/wholesale/whlwet/index.html). Its common names include pennywort, marsh pennywort and floating marsh pennywort. It has been listed as endangered in Illinois.

H. ranunculoides has a history of use as an ornamental plant, and is also used in certain (traditionally Asian) foods and beverages. In addition, it has been used in mixed constructed wetlands plantings for both treatment and mitigation purposes.

The applicant hasn't proven the exact mechanism by which close confinement with a living colony of H. ranunculoides induces settling of fine suspended solids in water. Highly educated experts phytoremediation and related fields have offered multiple competing theories. However, the operational utility of applicant's method has been validated by the applicant through direct observation of effect and measurement of functional water treatment value in full scale experimental trial at Portland, Oreg. (see aforementioned paper included later in this application). In some way, confined exposure of the contaminated water to the living plant material overcomes negative electrical charges carried by the fine suspended particles which are on account of these charges otherwise resistant to settling, allowing them to agglomerate and settle in a manner previously only observed with the introduction of chemical flocculants or a metal plate with a positive electrical charge.

The mechanism by which H. ranunculoides induces flocculation of fine suspended solids under conditions of confined exposure is a natural phenomena which may exist in other aquatic plants, but to the applicant's knowledge has only been demonstrated to have substantial utility in H. ranunculoides. Water treatment by flocculation of suspended solids with cultures of plant and animal microorganisms is routinely used in wastewater treatment systems, but small organisms, including small forbs such as duckweed (Lemna) are much more difficult to contain. Containment is desirable to avoid unwanted escape of plant material. One of the virtues of H. ranunculoides for applicant's method is that it is relatively easily confined.

A monoculture of H. ranunculoides is not required to implement applicant's method.

Other remedial functions of plants, such as consumption of excess nutrients, hyperaccumulation and rhizofiltration, have been demonstrated previously with a variety of plants. However, to the applicant's best knowledge, the concept of phyto-flocculation, or plant-induced flocculation, its confirmation with the use of H. ranunculoides, and it use in the applicant's method for the treatment of water for fine suspended solids are the discoveries of the applicant. First publication occurred in the applicant's aforementioned technical paper for the USEPA in late February, 2003 (citation of applicant's provisional patent application 60/446,983 dated 11 Feb. 2003 will follow by amendment, as required).

The mechanism is not critical to these claims. The operational and functional value of this method has been established by the applicant in full scale field trial with municipal stormwater vacuum eductor truck decant at Portland, Oreg.

Confinement with a living colony of H. ranunculoides plants may provide other previously recognized functions of plant exposure, such as consumption of excess nutrients, hyperaccumulation and rhizofiltration. The presence of such other previously recognized functions is not necessary to applicant's method and does not reduce or negate the positive value of the applicant's newly discovered method.

### SUMMARY

In accordance with the present invention, a method of water treatment for fine suspended solids by confined exposure to a living colony of the aquatic plant Hydrocotyle ranunculoides, a means of providing confined exposure of the water to the plant colony, such as a basin, tank, pipe, channel, drain, or sealed or lined ditch or sealed or lined pond confines a pool or stream of water to be treated with a living colony of the plant Hydrocotyle ranunculoides for sufficient duration to provide flocculation for fine suspended solids, while at least temporarily sustaining the life of the plant colony. In a preferred embodiment of the applicant's method, the means of confining the water with the plants is provided in the form of an open tank of 1 meter depth or less and the exposure is maintained for 24 hours or more.

### DETAILED DESCRIPTION—PREFERRED EMBODIMENT

In a preferred embodiment of the present invention, a method of water treatment for fine suspended solids by confined exposure of the water to be treated with a living colony of the aquatic plant, H. ranunculoides, the means of confining the water with the living plant colony is provided with a tank. Said tank is open at the top to admit sunlight, and the mature, living colony of H. ranunculoides plants forms a dense floating matt which substantially covers the surface of the water. In this preferred embodiment, the means of confining the water to be treated with a colony of H. ranunculoides plants includes one or more means of protecting the inflow and outflow from escape of the plant material, such as can be provided by baffles, mesh, or grates. In a preferred embodiment of the applicant's method, a means of confining the water together with the H. ranunculoides plant colony is provided which provides a maximum water depth of 1 meter or less. In a preferred embodiment of the applicant's method, the water to be treated is confined with the plant material so that exposure lasts 24 hours or more. A means of restricting the flow of water to be treated such as may be provided by valves or weirs, may be used to provide the preferred detention time. Longer detention times are desirable to provide more complete flocculation and settling of fine suspended solids.

### DETAILED DESCRIPTION—PREFERRED EMBODIMENT—OPERATION AND MAINTENANCE

Cultural requirements of H. ranunculoides are similar to other ornamental aquatic plants—water, light, air and moderate temperatures. The full scale trial in which utility was proven for this method occurred in US agricultural climate zone 6 conditions with municipal stormwater vacuum eductor truck waste decant. No special cultural requirements were found. Addition of heat, such as may be provided by locating the means of confinement in proximity to sewerage pipe, may be needed in colder climates.

Unless disturbed, the flocculated solids will settle by gravity and accumulate on the bottom of the means of confinement. Options for removal include draining the tank to the level of the accumulated flocculated material, pushing back the plant matt and suctioning out the accumulated material by means such as a vacuum eductor truck. Alternatively, the means of confining the water with the plant material may include a means of inducing settled material to pool, such as a bottom contour to a deeper area or to a trench or vault, in which the flocculated material may settle and be more readily accessed for removal.

### DETAILED DESCRIPTION—PREFERRED EMBODIMENT—ADVANTAGES

From the description above, a number of advantages of my water treatment method become evident:
(b) To provide economy of operation. An experimental full scale trial embodiment similar to the preferred embodiment described above has provided treatment at costs on the order of 1/10th of competing technologies.
(c) To provide economy of implementation. A preferred embodiment may employ existing facilities to provide the required means of confinement.
(d) To provide for removal of fine suspended solids such as those 30 microns and less in size. An experimental full scale trial embodiment similar to the preferred embodiment described above has proven this capability, which has special value to the protection of endangered fish species.
(e) To provide greater adaptability to existing facilities and various physical settings. The means of providing the required confinement of the water to be treated with the plant colony may take a variety of forms.
(f) To provide worker safety advantages. The applicant's method can be implemented without electrical power or chemical handling.
(g) To provide reduced environmental impact compared to competing technologies. The applicant's method uses fewer resources than competing technologies.

### CONCLUSION, RAMIFICATIONS AND SCOPE OF INVENTION

Accordingly, the reader will see that this method can be used to treat water for fine suspended solids, such as contaminated silts and clays found in runoff from streets and roads, industrial or resource extraction activities, or construction sites, among others.

Competition for both public and private resources to support environmental services is fierce, while our appreciation of environmental needs such as water treatment is growing. The reader will see that the applicant's method is an appropriate, economical technology for accomplishing a needed form of water treatment.

Although the description above contains many specificities, these should not be construed as limiting the scope of the invention but as merely providing illustrations of some of the presently preferred embodiments of this invention. For example, the means of providing confinement of the water with the living plant colony could be provided by a wide variety of closed or open, portable or fixed tanks, ponds, trench drains, basins, etc., as long as the minimum horticultural needs of the plant material, including light, water and nutrients are provided, and the time of exposure is sufficient.

Thus the scope of the invention should be determined by the appended claims and their legal equivalents, rather than by the examples given.

1. A method of treating water for fine suspended solids consisting of confined exposure to a living colony of the aquatic plant, hydrocotyle ranunculoides.
